(19) United States
(12) Patent Application Publication
(10) Pub. No.: US 2012/0179391 A1
(43) Pub. Date: Jul. 12, 2012

(54) ELECTRONIC DEVICE AND DAMAGE DETECTING METHOD

(75) Inventors: Takahiro Omori, Kawasaki-shi (JP); Kenji Hirohata, Tokyo (JP); Minoru Mukai, Tokyo (JP)

(73) Assignee: KABUSHIKI KAISHA TOSHIBA, Tokyo (JP)

(21) Appl. No.: 13/418,458

(22) Filed: Mar. 13, 2012

Related U.S. Application Data
(63) Continuation of application No. PCT/JP2009/066549, filed on Sep. 24, 2009.

(51) Int. Cl. G06F 19/00; G01N 19/00

(52) U.S. Cl. 702/35

(57) ABSTRACT

There is provided with an electronic device including: an electronic board having at least one electronic component mounted via both of a target joint and a dummy joint; a vibration source to apply vibrations to the electronic board; a database configured to contain correlation between an electrical characteristic of the dummy joint and a damage value of the target joint, the damage value indicating a degree of crack growth of the target joint; a controller to drive the vibration source; an electrical characteristic measuring unit configured to measure an electrical characteristic of the dummy joint during the vibration source is driven; and a damage calculating unit configured to calculate a damage value of the target joint based on the electrical characteristic of the dummy joint measured by the electrical characteristic measuring unit and the correlation stored in the database.

### CROSS REFERENCE TO RELATED APPLICATIONS

This application is a Continuation Application of International Application No. PCT/JP2009/66549, filed on Sep. 24, 2009, the entire contents of which is hereby incorporated by reference.

### FIELD

An embodiment relates to an electronic device and a damage detecting method thereof.

### BACKGROUND

In a portable electronic device such as a cellular phone, many surface-mount components are soldered on a mount board. Such components in a portable device are more likely to be subjected to mechanical external forces such as an external impact and vibrations (e.g., a drop or on-board installation) than in a stationary electronic device. A thermal stress is generated by internal temperature variations as in a stationary device, so that a mechanical external force should be more carefully observed as a form of a load than in a stationary device. If such a mechanical external force causes damage on components themselves or faulty electrical connection, a serious functional problem may occur.

Among defective phenomena, crack growth on a soldered part is difficult to detect and thus may lead to a serious failure. A crack growth rate on a solder joint varies widely with a load applied to the joint and a strain caused by the load. In other words, the crack growth rate varies with a mechanical external force acting as a load. Thus, even if an application of an external force does not lead to a failure, the repeatedly applied external force may cause a failure. If the degree of crack growth can be detected as damage, a failure caused by a repeatedly applied mechanical load can be predicted. Hence, an unexpected malfunction caused by a break on a solder joint can be predicted. For this reason, a technique for detecting damage is necessary.

JP-A 2002-76187(Kokai) describes an example of this technique. A voltage is always applied to a point that is likely to be electrically broken in a ball grid array (BGA) and the voltage is monitored to detect a stress level. According to JP-A 2002-76187(Kokai), electric board warpage caused by fluctuations in environmental temperature is detected by measuring a resistance value at a measured point all the time, so that a break on a joint can be detected beforehand.

However, a significant change in electrical characteristics (such as a direct current resistance and an impedance) is not observed until just before a grown crack causes a soldered point to peel off and crack growth is difficult to electrically detect by an ordinary method. There are two main reasons: one reason is that a grown crack with a small connected portion does not vary in electrical characteristics in the low frequency region of an electrical signal passing through the connected portion. The other reason is that a cracked portion is kept in a contact state and thus allows signal transmission from a contacted portion.

For these reasons, crack growth on a solder joint cannot be confirmed until the solder joint is substantially completely broken.

### BRIEF DESCRIPTION OF THE DRAWINGS

FIG. 1 is a block diagram illustrating the configuration of an electronic device according to an embodiment;

FIG. 2 is a flowchart showing the flow of a damage detecting method according to the embodiment;

FIG. 3 is a perspective view illustrating a part of a ball grid array (BGA) package;

FIG. 4 is a side view of the configuration of FIG. 3;

FIG. 5 illustrates an example in which bumps around corner bumps are also used as dummy bumps;

FIG. 6 is a schematic diagram illustrating the internal configuration of a cellular phone;

FIG. 7 is a perspective view illustrating a part of a quad flat package (QFP);

FIG. 8 is an explanatory drawing showing the relationship between a vibration input amplitude and an output amplitude;

FIG. 9 shows a change in the electrical characteristics of the joint with the development of damage on the joint;

FIG. 10 is an explanatory drawing of equation (1) and equation (2);

FIG. 11 shows the relationship between a vibration form and a board shape;

FIG. 12 shows the relationship between a change in curvature radius or a change in displacement and a strain amplitude;

FIG. 13 shows the relationship between the damage values of a dummy joint and a target joint;

FIG. 14 is an explanatory drawing of a method of creating a damage/electrical characteristic database; and

FIG. 15 shows an example of the damage/electrical characteristic database.

### DETAILED DESCRIPTION

There is provided with an electronic device including: an electronic board, a vibration source, a database, a controller and a damage calculating unit.

The electronic board has at least one electronic component mounted thereon via both of a target joint and a dummy joint.

The vibration source applies vibrations to the electronic board.

The database contains correlation between an electrical characteristic of the dummy joint and a damage value of the target joint, the damage value indicating a degree of crack growth of the target joint.

The controller drives the vibration source.

The electrical characteristic measuring unit measures the electrical characteristic of the dummy joint during the vibration source is driven.

The damage calculating unit calculates the damage value of the target joint based on the electrical characteristic of the dummy joint measured by the electrical characteristic measuring unit and the correlation stored in the database.

Below, the outline of an embodiment will be first described.

In the case where an electronic device is deformed (e.g., curling of a board) in a connected state with crack growth on a solder bump or the like, the electrical characteristics may rapidly change and demonstrate unstable behaviors. For example, a chip capacitor in an electronic device such as a cellular phone may have a crack on a solder joint due to temperature fluctuations or mechanical loads such as vibrations and impacts, leading to a malfunction. Such an unstable phenomenon occurs because a crack on a solder joint normally in a contact state is opened by a deformation and varies the electrical characteristics. For example, an electronic device normally operating in ordinary times may rapidly stop operating when the electronic device is moved or rises in temperature. This phenomenon is a representative defective phenomenon of solder crack growth. Hence, before the occurrence of a defective phenomenon, if the joint is intentionally deformed by a vibration source or the like without breaking the joint and the electrical characteristics can be examined at the same time, the degree of crack growth can be measured as a change of the electrical characteristics.

In many cases, however, a circuit for measuring electrical characteristics is difficult to mount in a typical electronic component in consideration of a space, cost, wiring, and so on. In this case, the electrical characteristics of a target component cannot be directly measured, precluding the use of the foregoing measuring technique.

In the present embodiment, a device for measuring electrical characteristics is provided as a canary device and a method of estimating, based on the electrical characteristics of a joint of the canary device (dummy joint), damage on a joint of a device to be measured (target joint) is proposed. The canary device is a detector whose name is derived from a canary once used for detecting poison gas in coal mines. In the use of the canary device, a detecting device (canary device) is disposed at a point carrying a larger load than on a joint to be measured and then a failure is caused to occur first on a joint of the canary device. Thus, the danger of the joint to be measured can be predicted.

The relationship between the electrical characteristic of the joint of the canary device and the damage value of the joint to be measured is examined beforehand by testing or simulation, and then the relationship is stored in a database, so that the electrical characteristics of the joint to be measured can be indirectly examined based on the electrical characteristics of the joint of the canary device.

In the present embodiment, a vibration source such as a vibration actuator is used to apply a load (board deformation) to a joint of a mounted component. Many electronic devices contain mechanical actuators acting as movable parts. A representative electronic device containing a vibration actuator is a cellular phone. A cellular phone includes a small vibration actuator for arrival call notification in silent mode. Vibrations of a vibration actuator need to have a large exciting force enabling notification to a human body, so that the vibrations can be induced to a chassis and a board. A joint of the canary device is deformed by the exciting force while the degree of crack growth (cumulative fatigue) on a target joint is checked by inspecting an electrical characteristic.

The embodiment will be specifically described below with reference to the accompanying drawings.

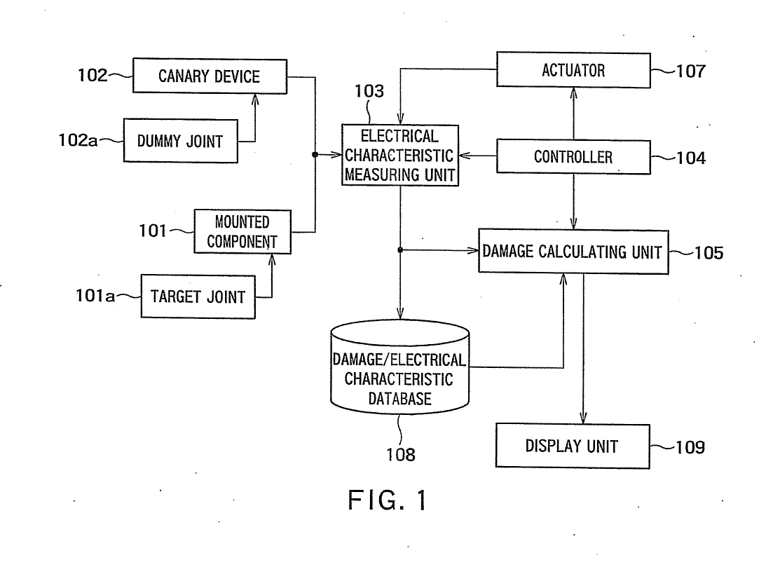

FIG. 1 is a block diagram illustrating the configuration of an electronic device according to the embodiment.

The electronic device includes an electronic board (hereinafter, will be simply referred to as a board) having a mounted component 101 and a canary device 102. The board is disposed in, for example, a mobile communication device (e.g., a cellular phone) or an electronic device such as a PC. The mounted component 101 is connected to the board via a target joint 101a. The canary device 102 is connected to the board via a dummy joint 102a. The dummy joint 102a is disposed at a point that is likely to be broken before the target joint 101 is broken by a cumulative load, e.g., vibrations applied to the board. In other words, the dummy joint 102a is disposed at a point having shorter life than the target joint 101a against a load. In the present embodiment, the target joint 101a and the dummy joint 102a are both solder bumps (solder joints). The dummy joint 102a and the target joint 101a may be the solder joints of the same device or the solder joints of different devices.

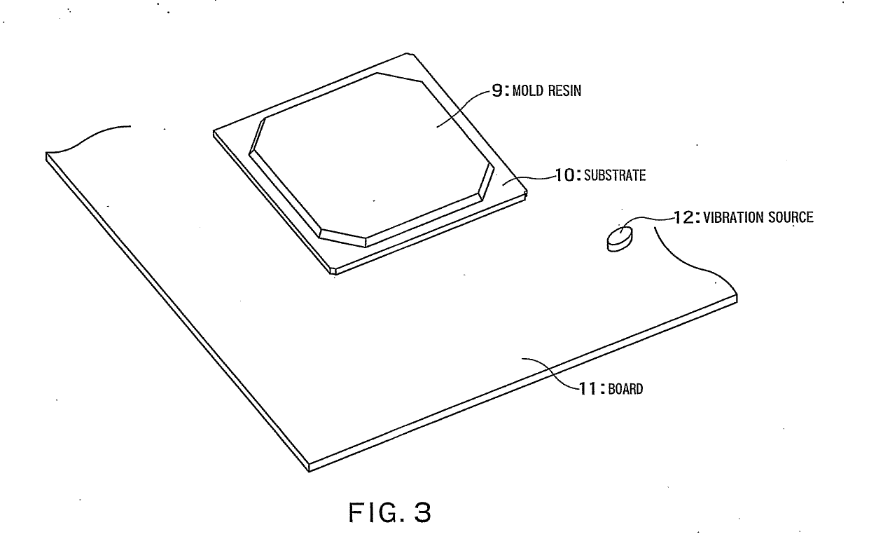

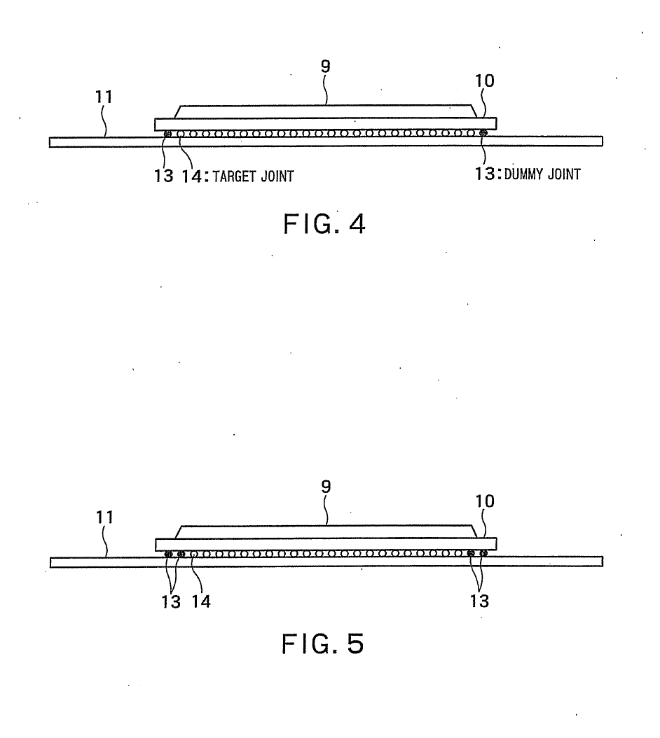

FIG. 3 is a perspective view illustrating a part of a package configuration of a ball grid array (BGA) that is configures as in FIG. 1. FIG. 4 is a side view of the configuration of FIG. 3. Components (including a controller 104, a damage calculating unit 105, an electrical characteristic measuring unit 103, and a damage/electrical characteristic database 108 in FIG. 1) are covered with mold resin 9 on a substrate 10. The substrate 10 is joined to an electric board 11 via solder bumps (solder joints). In FIG. 3, a vibration source 12 (corresponding to a vibration actuator 107 in FIG. 1) is slightly separated from the substrate 10 on the board 11. In this configuration, the mounted component 101 and the dummy component 102 correspond to the substrate 10, and the dummy joint 102a and the target joint 101a correspond to solder joints between the substrate 10 and the board 11.

Specifically, as illustrated in FIG. 4, at least one of corner solder bumps acts as a dummy bump 13 (corresponding to the dummy joint 102a in FIG. 1) and at least one solder bump other than the dummy bump 13 acts as a solder bump 14 to be measured (corresponding to the target joint 101a in FIG. 1). The at least one dummy bump 13 is correlated with one of the solder bumps (solder joints) 14 beforehand. A crack on the solder bumps typically develops from the outer corner bumps. In many cases, at points less resistant to cracking, bumps act as dummy bumps that are not used for signal transmission. Thus, the dummy bumps are preferably used as dummy joints of the canary device.

The locations of the bumps acting as the dummy joints 102a do not need to be limited to the four corners. In a typical damage pattern, corner bumps are first broken and then other bumps are sequentially broken from the outside to the inside. In FIG. 5, bumps around the corner bumps also act as dummy bumps, so that cumulative damage (crack growth) on the target joint can be estimated in more detail by repeating the processing of the present embodiment every time a break occurs on the bumps. In other words, higher measurement accuracy can be expected.

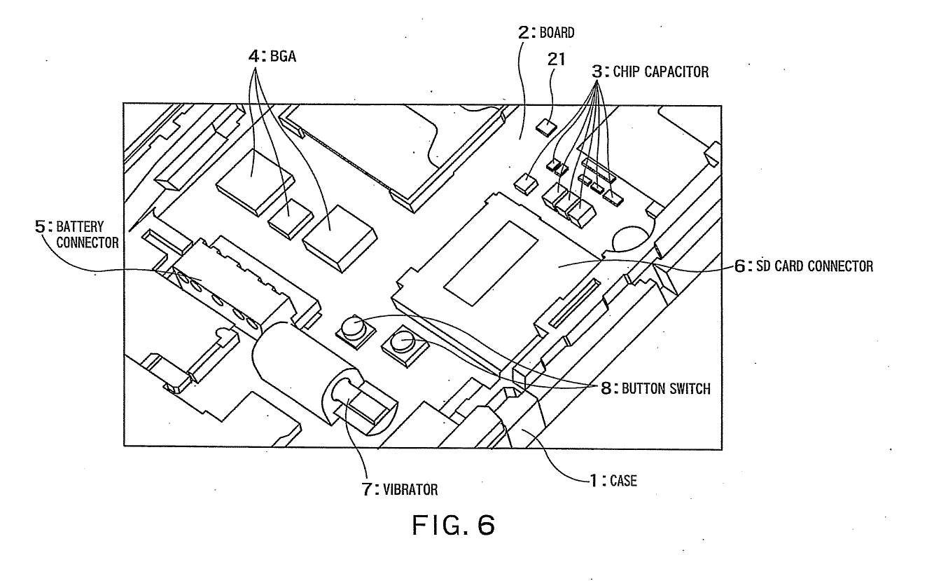

In the examples of FIGS. 3, 4, and 5, the mounted component 101 and the canary device 102 correspond to the same component (substrate). FIG. 6 illustrates an example in which the mounted component 101 and the canary device 102 correspond to different components. FIG. 6 schematically illustrates the internal configuration of a cellular phone. A board 2 is disposed in a chassis 1. Many chip capacitors 3, BGAs 4, a battery connector 5, an SD card connector 6, a vibrator 7 (corresponding to the vibration actuator 107 in FIG. 1), button switches 8, and a chip resistor (canary device) 21 are disposed on the board 2. In this example, at least one of the chip capacitors 3 corresponds to the mounted component 101 and the chip resistor 21 corresponds to the canary device 102.

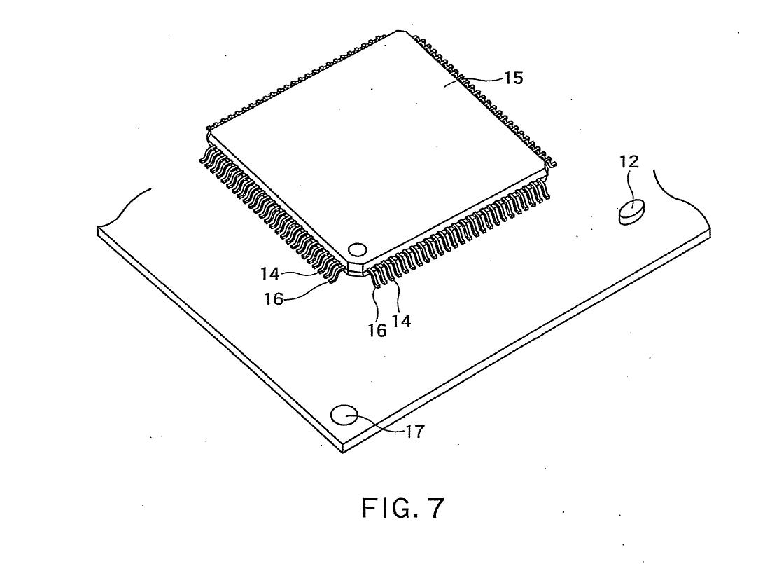

In another example, the present embodiment is also applicable to a package 15 that is a quad flat package (QFP) illustrated in FIG. 7. The package 15 is connected onto the board via leads. The vibration source 12 (corresponding to the vibration actuator 107 in FIG. 1) is disposed on the board. Since crack grows from the leads on the four corners, at least one of the corner leads is used as a dummy lead (dummy joint) 16 of the canary device and at least one lead 14 of other QFP leads is used as a target joint. More desirably, the lead close to a boss hole 17 is used as a dummy joint in consideration of a deformed shape, in relation to a standard power transmission path. The boss hole 17 serves as a connected portion between the board and the chassis.

Returning to FIG. 1, the electrical characteristic measuring unit 103 measures an electrical characteristic on the dummy joint 102a of the canary device 102 in response to a command from the controller 104. Electrical characteristics generally include a direct current resistance and an impedance. In the case of a capacitor, a coil, and so on, fluctuations in capacitance or inductance may be examined.

The vibration actuator 107 is a vibration source that is disposed on the board to apply vibrations of a predetermined magnitude to a point on the board. The vibration actuator 107 is driven by the controller 104. The vibration source is not limited to the vibration actuator 107. Any other devices such as speakers may be used as long as vibrations can be applied. The actuator for applying vibrations is not limited to an internal component. Thus, vibrations may be applied by an external impact or an external vibrator.

The controller 104 controls the electrical characteristic measuring unit 103, the actuator 107, and the damage calculating unit 105. When detecting the occurrence of a predetermined inspection event, the controller 104 drives the actuator 107. While the actuator 107 vibrates, the controller 104 measures an electrical characteristic on the dummy joint 102a of the canary device 102 by means of the electrical characteristic measuring unit 103. Then, the controller 104 instructs the damage calculating unit 105 to calculate a damage value indicating the degree of crack growth on the target joint 101a, based on the measured electrical characteristic. For example, the controller 104 may drive the actuator 107 in response to the detection of a beforehand specified event, for example, an incoming call to a cellular phone. Alternatively, the controller 104 may drive the actuator 107 to measure the electrical characteristic when receiving an input of a damage calculating instruction from a user. In the case where an acceleration sensor is mounted in a cellular phone, an acceleration of at least a fixed value as an external force to the acceleration sensor may be detected to examine an electrical characteristic at that time. Also in this case, substantially the same measurement result can be obtained as in the driving of the actuator 107.

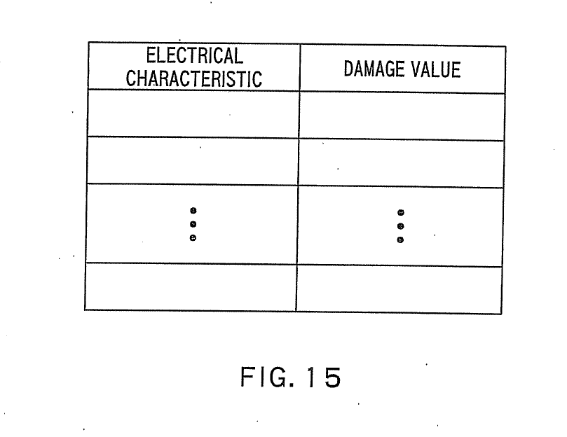

The damage/electrical characteristic database 108 contains the electrical characteristic of the dummy joint 102a and the corresponding damage value of the target joint 101a. FIG. 15 shows an example of the format of the damage/electrical characteristic database 108. A method of creating the damage/electrical characteristic database 108 will be described later.

The damage calculating unit 105 calculates the damage value of the target joint 101a of the mounted component 101 in response to a command from the controller 104. The damage value is calculated by using the measured electrical characteristic and the damage/electrical characteristic database 108.

The damage calculating unit 105 determines the damage value of the target joint corresponding to the electrical characteristic measured by the electrical characteristic measuring unit 103, according to the damage/electrical characteristic database 108. In the absence of a matching electrical characteristic value, linear complementation or the like may be performed to calculate a damage value or a damage value corresponding to the closest electrical characteristic may be obtained.

The damage calculating unit 105 outputs data on the calculated damage value to a display unit 109. Alternatively, the damage calculating unit 105 may determine a difference between a predetermined life value (e.g., 1) and the calculated damage value as a remaining life and then output data on the remaining life to the display unit 109. In the case where the damage value exceeds a certain threshold value, the damage calculating unit 105 may decide that the target joint is close to the end of the life and then perform a predetermined action. The predetermined action is notification of various messages to the user through the display unit 109. For example, the user is notified of maintenance or a contact address for user support. Moreover, the actuator 107 is vibrated in a specific pattern to notify the user of a message.

The display unit 109 displays data or messages from the damage calculating unit 105.

The following will describe the oscillation frequency of the actuator 107 and the method of creating the damage/electrical characteristic database 108.

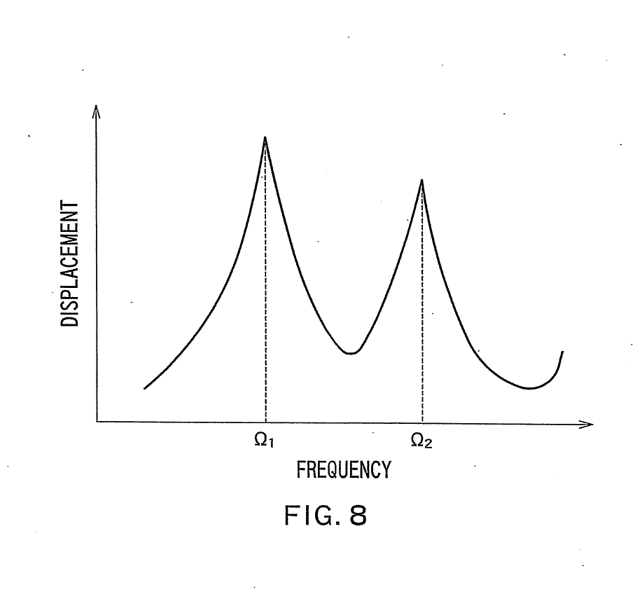

FIG. 8 is an explanatory drawing showing the relationship between a vibration input amplitude and an output amplitude.

Generally, a vibration input amplitude and an output amplitude depend on a frequency. In FIG. 8, Ω₁ and Ω₂ are natural frequencies. It is found that a large amplitude can be obtained as a vibration frequency to be inputted comes closer to the natural frequencies. Thus, vibrations at frequencies close to the natural frequencies are desirably inputted in order to reliably obtain a change of electrical characteristics according to the degree of crack growth on the joint. Needless to say, it is desirable to avoid large-amplitude vibrations that develop damage. The values of the natural frequencies are set when a mechanical structure is determined. Thus, it is recommended that the values of the natural frequencies are obtained by an experiment or simulation upon designing and then are used as information when an oscillation frequency is determined. For example, the board having the mounted component 101, the canary device 102, and the actuator 107 are fixed (attached) to the chassis, and then the value of the natural frequency of the board in this state is used as the oscillation frequency of the actuator 107.

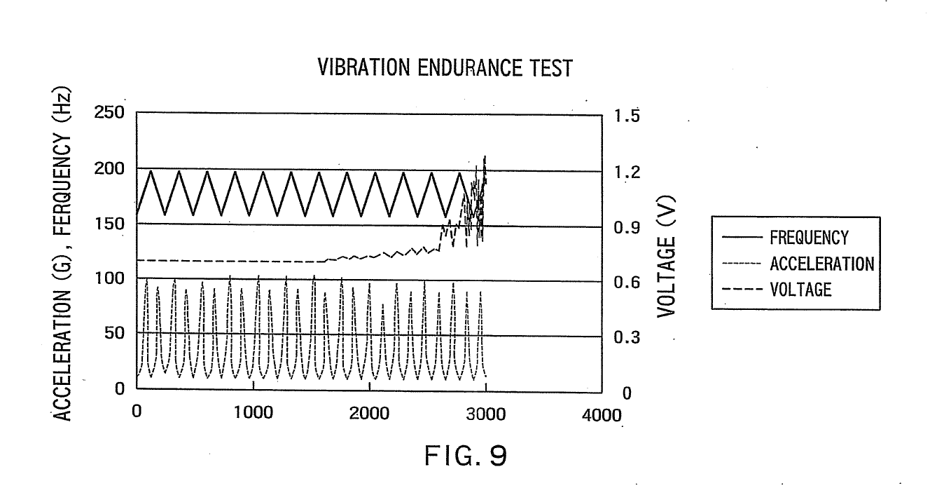

FIG. 9 shows an example of a measurement of a resistance change (actually, a voltage change measured with a constant current) on the solder joint, during frequency sweep at ±20 Hz around the natural frequency on the board having a BGA. The frequency sweep repeatedly applies a strain amplitude Δε, thereby developing damage on the solder joint.

As shown in FIG. 9, a resistance value fluctuated with the development of damage during vibrations. Furthermore, a resistance value (voltage value) increased with the development of damage. After a vibration test, however, a resistance value measured without vibrations was substantially equal to the resistance value of the original state (not shown). Hence, it is confirmed that a resistance change during vibrations is useful for estimating damage.

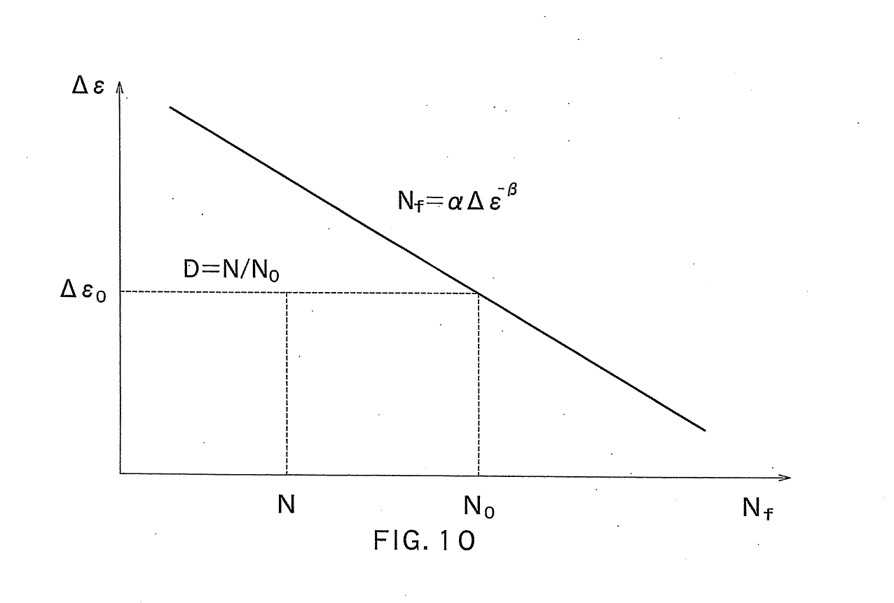

FIG. 10 is an explanatory drawing showing that a fatigue fracture on a material is determined by the value of a strain amplitude and the number of repetitions. Specifically, FIG. 10 shows the relationship of equation (1) below:

N_{f}=αΔε^{-β} Equation (1)

D=N/N_{f} Equation (2)

Δε: strain amplitude
αβ: constant determined by a material
N_{f}: the number of cracking cycles (the number of life cycles at

which the material is broken by the strain amplitude Δε)

N: the number of cycles of the actual application of the strain amplitude Δε (the number of repeated cycles)
D: damage value (the ratio of the number of cycles added through the present relative to the number of life cycles)

Equation (1) is known as, for example, the Coffin-Manson law (the number of cycles is about 10³ or less) and the Basquine law (the number of cycles is about 10⁴ or more).

As shown in FIG. 10, the number of cracking cycles at an amplitude of Δε₀ is N₀ according to equation (1). Therefore, when a strain amplitude of Δε₀ is applied N times (N cycles), a damage value D is calculated as D=N/N₀ according to equation (2). The number of cracking cycles N_{f} and constants α and β are determined beforehand by testing.

In the present embodiment, the strain amplitude Δε is a constant value. Even in the case where the strain amplitude has a typical waveform, a damage value can be calculated substantially in a similar manner by summing damage values obtained by strain amplitudes and the number of repeated cycles at their strain amplitudes as expressed by equation (3) below.

Dₛᵤₘ=N₁/N_{f,1}+N₂/N_{f,2}+ . . . +Nₙ/N_{f,n}=N₁/αΔε₁^{-β}N₂/αΔε₂^{-β}+ . . . Nₙ/αΔεₙ^{-β} Equation (3)

Dₛᵤₘ: damage value when different strain amplitudes are applied
Δε₁ . . . . Δεₙ: strain amplitude
N₁ . . . Nₙ: the number of cycles at the application of strain amplitudes Δε₁ . . . , Δεₙ

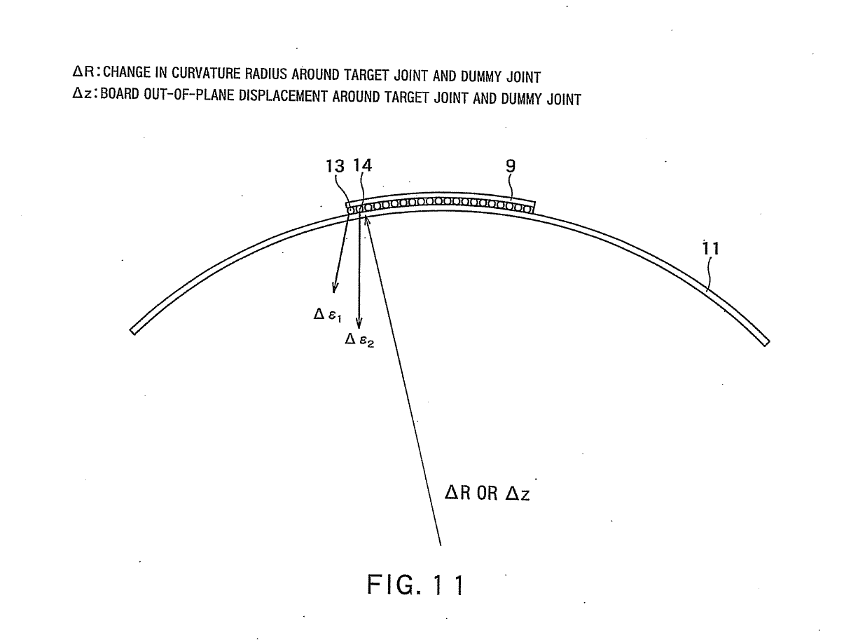

Referring to FIGS. 11 to 13, the following will discuss building of the relationship between the strains of the dummy joint and the target joint and the relationship between the damage values of the dummy joint and the target joint.

As shown in FIG. 11, a load applied to the joint by vibrations is typically generated by the primary natural vibration form (bending vibration) of the board. In this case, the vibration form is uniquely determined and thus the shape of the board around the solder bumps can be represented by a curvature radius R and a displacement z.

Since a damage value is the function of a strain amplitude (see equation (1)), the damage value of the target joint can be estimated from the damage value of the dummy joint by identifying the relationship between the strain amplitudes of the dummy joint and the target joint.

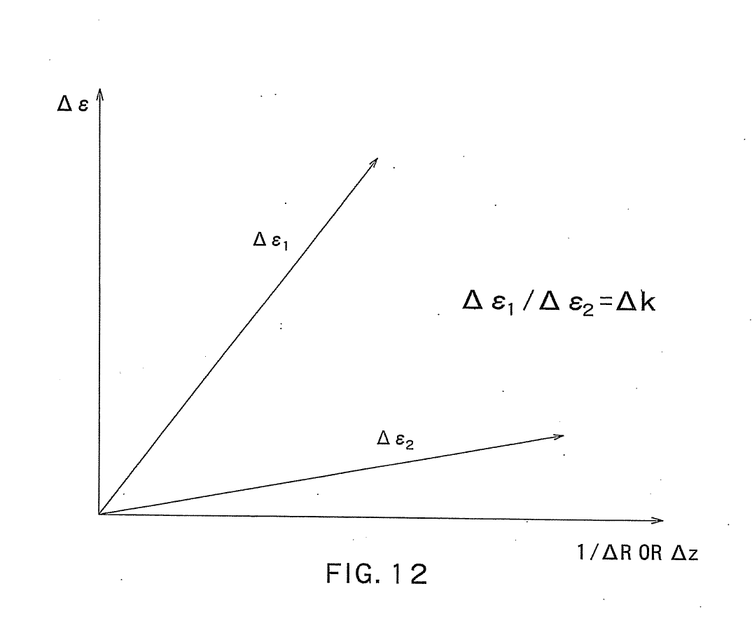

Therefore, as shown in FIG. 12, the relationship between a change ΔR in curvature radius or a change Δz in displacement and the strain amplitudes Δε₁ and Δε₂ of the dummy joint and the target joint is determined beforehand by the finite element method. In this case, a change in curvature radius or a change in displacement is also determined when vibrations are applied by the actuator. Therefore, the relationship between the strain amplitude Δε₁ of the dummy joint and the strain amplitude Δε₂ of the target joint can be calculated as Δε₁/Δε₂=Δk.

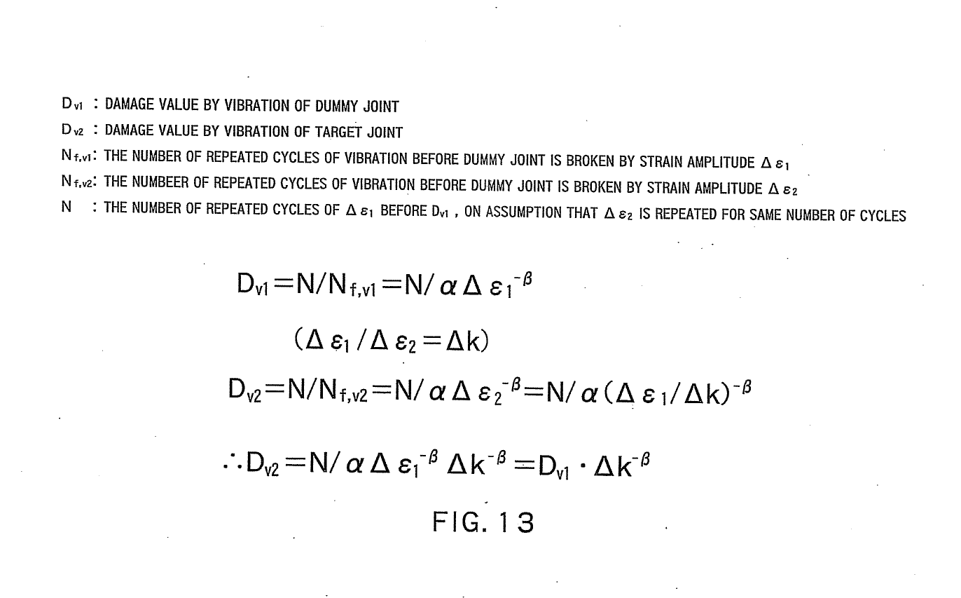

Hence, as shown in FIG. 13, a damage value Dᵥ₂ of the target joint can be estimated based on a damage value Dᵥ₁ of the dummy joint as expressed by equation (4) below.

Dᵥ₂=Dᵥ₁·Δk^{-β} Equation (4)

As described above, an amount of curvature of the board is determined by estimating a load applied to the board and strain values (strain amplitudes) occurred on the dummy joint and the target joint are used to obtain the relationship between damage occurred on the dummy joint and the target joint.

A method of creating the damage/electrical characteristic database 108 will be described below based on the foregoing explanation.

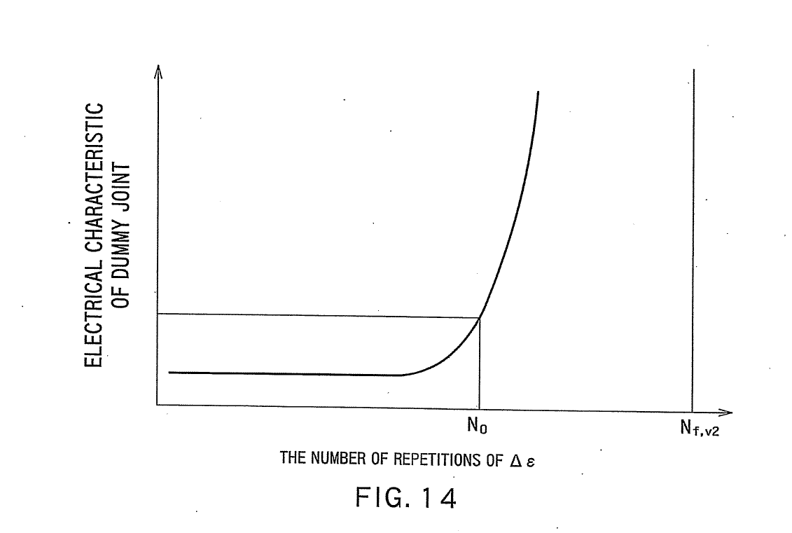

(1) A test piece for the target joint and a test piece for the dummy joint are prepared on the board. The board is vibrated to repeatedly apply the strain amplitude Δε₂ to the target joint; meanwhile, an electrical characteristic R (e.g., a resistance) of the dummy joint is measured. FIG. 14 shows the state of the measurement. The number of cracking cycles N_{f,v2} is calculated beforehand based on the amplitude Δε₂ and the relationship of equation (1). In FIG. 14, when the number of repetitions is N₀, an electrical characteristic is measured as Ro. The relationship between the number of repetitions (the number of cycles) N and the electrical characteristic R is recorded during the measurement. For example, the measurement is continued until the dummy joint is broken. It is assumed that the number of repetitions of the dummy joint is equal to that of the target joint. At the completion of the measurement, the damage value Dᵥ₂ is determined by dividing the measured number of repetitions (the number of cycles) R by the number of cracking cycles N_{f,v2}. Thus, the relationship between the electrical characteristic of the dummy joint and the damage value of the target joint is obtained (see FIG. 15). This relationship can be expressed as Dᵥ₂=f(R)=N/N_{f,v2}. Based on the relationship, a function that approximates the relationship between the electrical characteristic and the damage value may be created and used as the damage/electrical characteristic database 108.

(2) In another method, a test piece (dummy joint) is first prepared on the board and then the strain amplitude Δε₁ is repeatedly applied to the test piece; meanwhile, the measurement of the electrical characteristic R on the test piece is continued until the test piece is broken. During the measurement, the number of repetitions N of the strain amplitude Δε₁ and the corresponding electrical characteristic R are recorded. Then, according to equation (2), a ratio N/N_{f,v1} is calculated as the damage value Dᵥ₁ of the dummy joint. The ratio N/N_{f,v1} is the ratio of the number of repetitions N and the number of repetitions (the number of cracking cycles) N_{f,v1} when the dummy joint is broken. Moreover, based on the relationship of equation (4) obtained beforehand, the damage value Dᵥ₂ of the target joint is calculated from the damage value Dᵥ₁ of the dummy joint. In this way, the relationship between the electrical characteristic R of the dummy joint and the damage value Dᵥ₂ of the target joint is obtained.

(3) In still another method, the strain amplitude Δε₁ of the dummy joint, the strain amplitude Δε₁ of the target joint, and so on are determined and the damage value Dᵥ₂ of the target joint is calculated based on equation (4) when the damage value Dᵥ₁ of the dummy joint is 1 (when the dummy joint is broken). Moreover, the electrical characteristic is calculated by simulation or in theory when the dummy joint is broken (for example, in the case where the electrical characteristic is a resistance value, the electrical characteristic is regarded as infinity). Then, the electrical characteristic and the calculated damage value Dᵥ₂ of the target joint are correlated with each other and stored as the damage/electrical characteristic database 108. This method is effective for estimating the damage value of the target joint when the dummy joint is broken (when the electrical characteristic considerably changes and a break is completely detected).

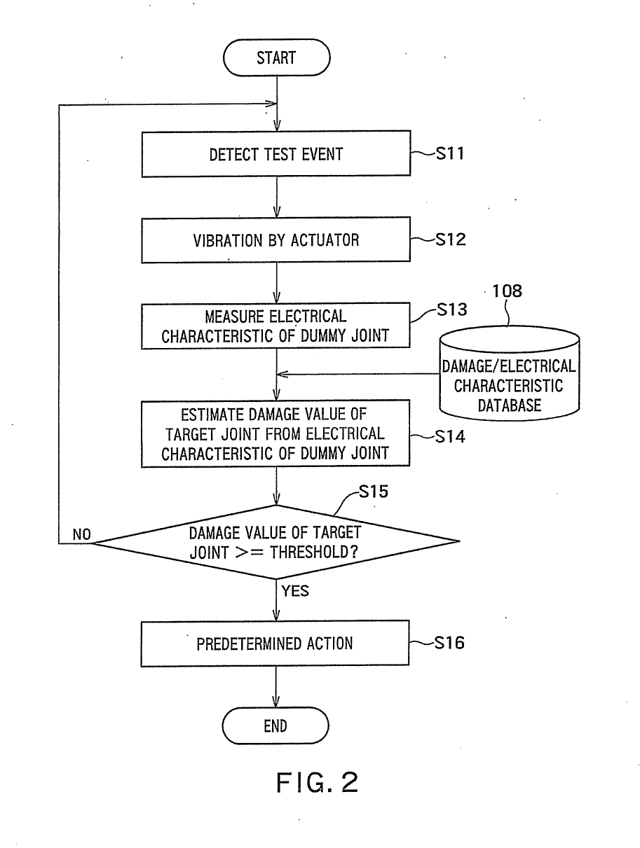

FIG. 2 is a flowchart showing the flow of the damage detecting method according to the embodiment.

When the controller 104 detects a predetermined test event (S11), the board is vibrated by the actuator 107 for a predetermined period (S12). The controller 104 instructs the electrical characteristic measuring unit 103 to measure the electrical characteristic of the dummy joint 102a and instructs the damage calculating unit 105 to calculate the damage value of the target joint 101a.

The electrical characteristic measuring unit 103 measures the electrical characteristic of the dummy joint 102a in response to an instruction from the controller 104 and transmits a measured value to the damage calculating unit 105 (S13).

The damage calculating unit 105 accesses and searches the damage/electrical characteristic database 108 for a corresponding damage value in response to an instruction from the controller 104 based on the electrical characteristic value received from the electrical characteristic measuring unit 103.

The damage calculating unit 105 decides whether the retrieved damage value is at least a threshold value or not (S15). In the case where the damage value is at least the threshold value (YES), the damage calculating unit 105 performs a predetermined action (S16). For example, when deciding that the target joint is nearly broken, the damage calculating unit 105 outputs notification of maintenance to the display unit 109. Multiple threshold values may be set and a different action may be performed every time a damage value exceeds the threshold values. In the case where the retrieved damage value is smaller than the threshold value (NO in S15), the process returns to step S11 and then advances to step S12 when the predetermined test event is detected.

The present embodiment makes it possible to recognize a sign of a failure caused by crack growth on the solder joint, thereby quickly advancing to subsequent actions including component replacement and data storage.

In FIG. 1, the damage calculating unit 105, the controller 104, and the electrical characteristic measuring unit 113 may be configured by hardware or program modules. In the case of program modules, the program modules are stored in recording media such as a nonvolatile memory and a hard disk, are read from the recording media by a computer, e.g., a CPU, and then are expanded in memory units such as RAM or directly executed. The database 108 may include, for example, recording media such as a memory unit, a hard disk, a CD-ROM, and a USB memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic device comprising:
an electronic board having at least one electronic component mounted thereon via a target joint and a dummy joint;
a vibration source to apply vibrations to the electronic board;
a database to contain correlation between an electrical characteristic of the dummy joint and a damage value of the target joint, the damage value indicating a degree of crack growth of the target joint;
a controller to drive the vibration source;
an electrical characteristic measuring unit to measure the electrical characteristic of the dummy joint during the vibration source is driven; and
a damage calculating unit configured to calculate the damage value of the target joint based on the electrical characteristic of the dummy joint measured by the electrical characteristic measuring unit and the correlation stored in the database.

2. The device according to claim 1, further comprising a chassis to which the electronic board is fixed,
wherein an oscillation frequency of the vibration source includes a natural frequency of the electronic board in a state that the electric board is fixed to the chassis.

3. The device according to claim 2, wherein the electrical characteristic is one of a resistance value, a capacitance, an inductance, and an impedance.

4. The device according to claim 3, wherein the damage calculating unit performs a predetermined action if the damage value calculated by the damage calculating unit is equal to or greater than a threshold value.

5. The device according to claim 4, further comprising a display unit to display data,
wherein the damage calculating unit displays a predetermined message on the display unit as the predetermined action.

6. A method for detecting damage of an electronic board on which at least one electronic component is mounted via both of a target joint and a dummy joint, comprising:
applying vibrations to the electronic board;
measuring an electrical characteristic of the dummy joint during the vibrations is applied;
accessing a database to contain correlation between an electrical characteristic of the dummy joint and a damage value of the target joint, the damage value indicating a degree of crack growth of the target joint; and
calculating a damage value of the target joint based on a measured electrical characteristic of the dummy joint and the correlation stored in the database.
